(19) United States
(12) Patent Application Publication
(10) Pub. No.: US 2015/0251330 A1
(43) Pub. Date: Sep. 10, 2015

(54) Straw Hole Punching Apparatus

(71) Applicant: Gonzalo Garcia, Whittier, CA (US)

(72) Inventor: Gonzalo Garcia, Whittier, CA (US)

(21) Appl. No.: 14/542,141

(22) Filed: Nov. 14, 2014

Related U.S. Application Data
(60) Provisional application No. 61/948,763, filed on Mar. 6, 2014.

(51) Int. Cl. B26F 1/32

(52) U.S. Cl. CPC B26F 1/32

(57) ABSTRACT

A straw hole punching apparatus is a device utilized to create a hole in a beverage container through which a drinking straw may be inserted. The straw hole punching apparatus comprises a plunger that may be depressed into a tubular base structure. A cutting implement is attached to a socket within the plunger and is able to slide through a guide channel within the tubular base structure when the plunger is depressed. A spring encircling the socket and the guide channel ensures that the plunger returns to its original position when the plunger is released after being depressed. The plunger is retained within the tubular base structure by a lip and a spacing ring that ensure that the plunger does not eject from the tubular base structure due to force provided by the spring upon the user releasing the plunger.

The current application claims a priority to the U.S. Provisional Patent application Ser. No. 61/948,763 filed on Mar. 6, 2014.

### FIELD OF THE INVENTION

The present invention relates generally to a device for punching a hole into a surface. More specifically, the present invention is a straw hole punching apparatus for punching a hole into the surface of a beverage container.

### BACKGROUND OF THE INVENTION

When transporting a beverage, it is common to enclose the beverage into a dedicated container for both storage purposes and convenient access to the beverage when the carrier wishes to drink. When taking a drink from a container such as a bottle, a cap must generally be removed from the rim of the bottle before the drinker can bring the container to his or her lips and drink. The container must often be tilted in order to allow the beverage to escape from the interior of the container. Constantly removing a bottle cap and tilting the bottle to take a drink can be inconvenient or dangerous, particularly if the drinker is engaged in an activity such as operating a motor vehicle. In these types of situations, utilizing a straw can be convenient as a straw eliminates the need to constantly remove a cap from the bottle. Additionally, a straw eliminates the need to constantly lift the bottle to the drinker's mouth when taking a drink. However, many types of beverage containers are not designed to accommodate insertion of a straw to facilitate drinking. Oftentimes, a container straw hole is too large, resulting in larger chances of spilling the beverage within the container as well as increasing the magnitude of any spills that do occur. As such, a means of forming a suitably sized straw hole in a variety of beverage container is often desirable.

The present invention is a straw hole punching apparatus that allows the user to punch a straw hole into the surface of a beverage container. The straw hole punching apparatus is attachable to a beverage container into which the user wishes to insert a straw. The present invention is designed to create a straw hole without causing any material of the beverage container to fall into the beverage.

### BRIEF DESCRIPTION OF THE DRAWINGS

FIG. 1 is a perspective view of the present invention.

FIG. 2 is a side view of the plunger.

FIG. 3 is a cross-sectional view of the plunger taken along line A-A of FIG. 2.

FIG. 4 is a side view of the tubular base structure.

FIG. 5 is a cross-sectional view of the tubular base structure taken along line B-B of FIG. 4.

FIG. 6 is a side view of the present invention in a primed configuration.

FIG. 7 is a cross-sectional view of the present invention in a primed configuration taken along line C-C of FIG. 6.

FIG. 8 is a bottom view of the present invention.

FIG. 9 is a side view of the present invention in a pressed configuration.

FIG. 10 is a cross-sectional view of the present invention in a pressed configuration taken along line D-D of FIG. 9.

FIG. 11 is a perspective view of an alternative embodiment of the present invention with an alternative cutting implement.

### DETAIL DESCRIPTIONS OF THE INVENTION

All illustrations of the drawings are for the purpose of describing selected versions of the present invention and are not intended to limit the scope of the present invention.

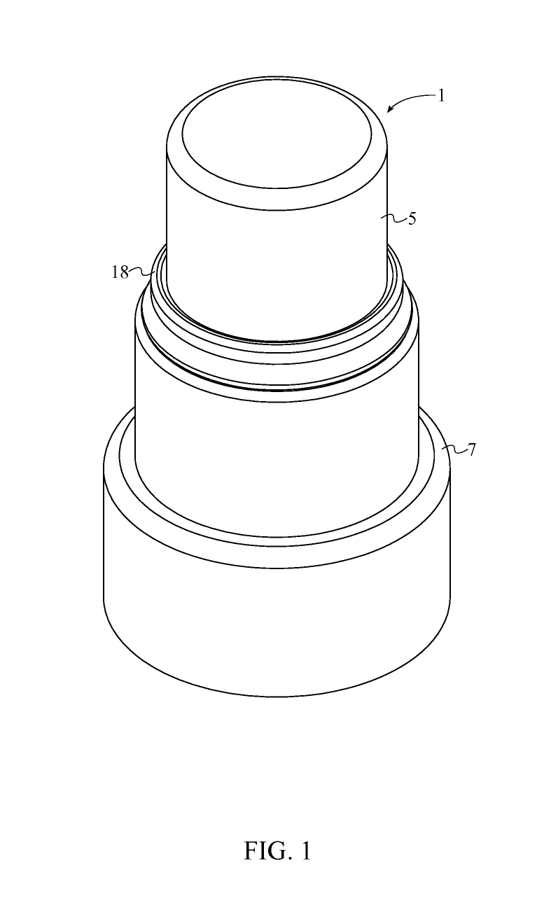

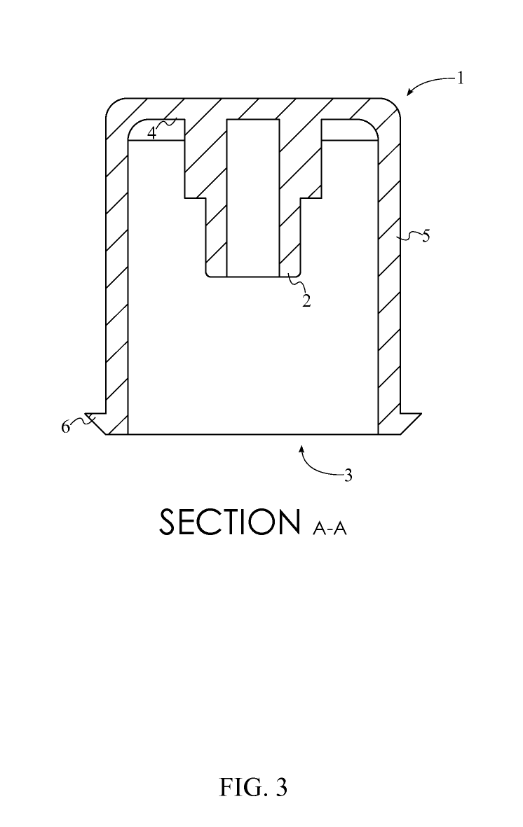

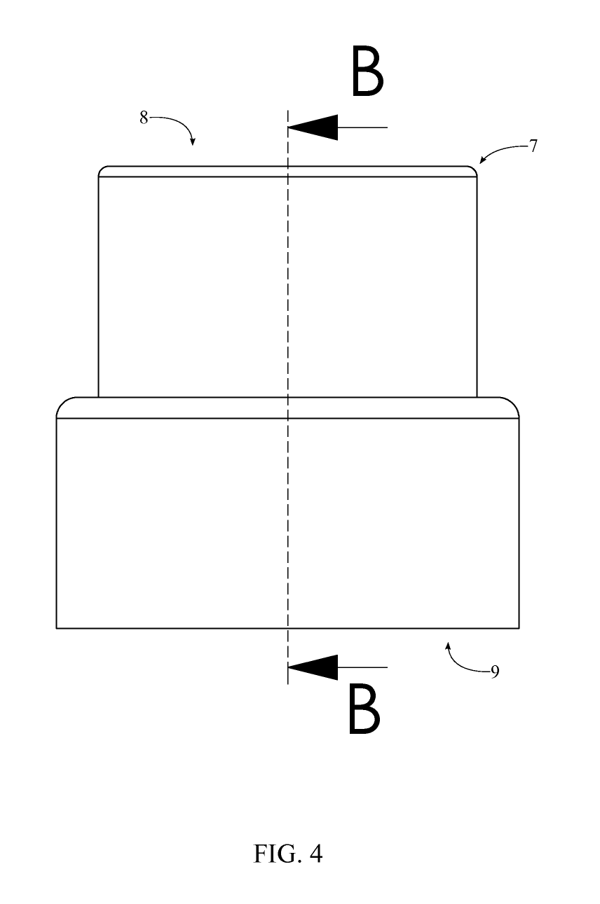

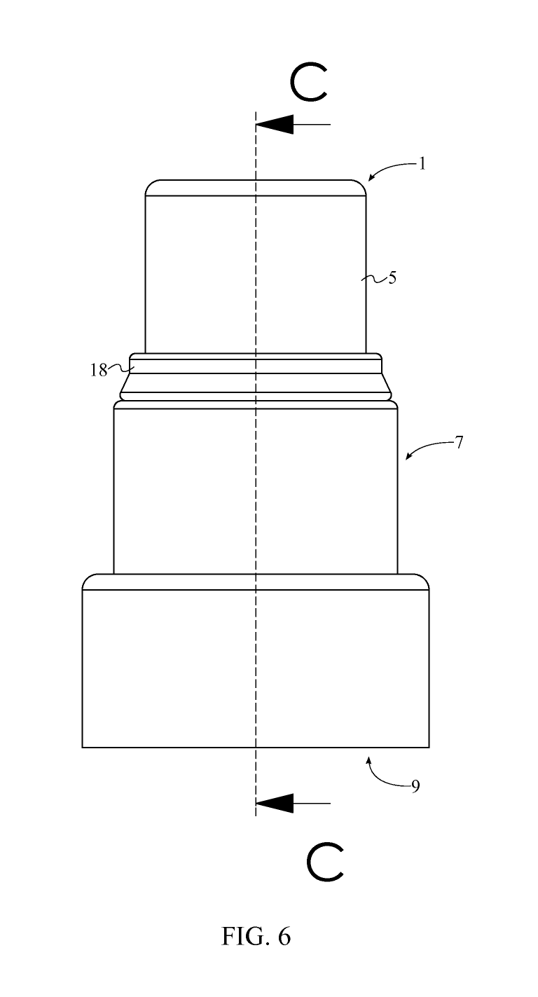

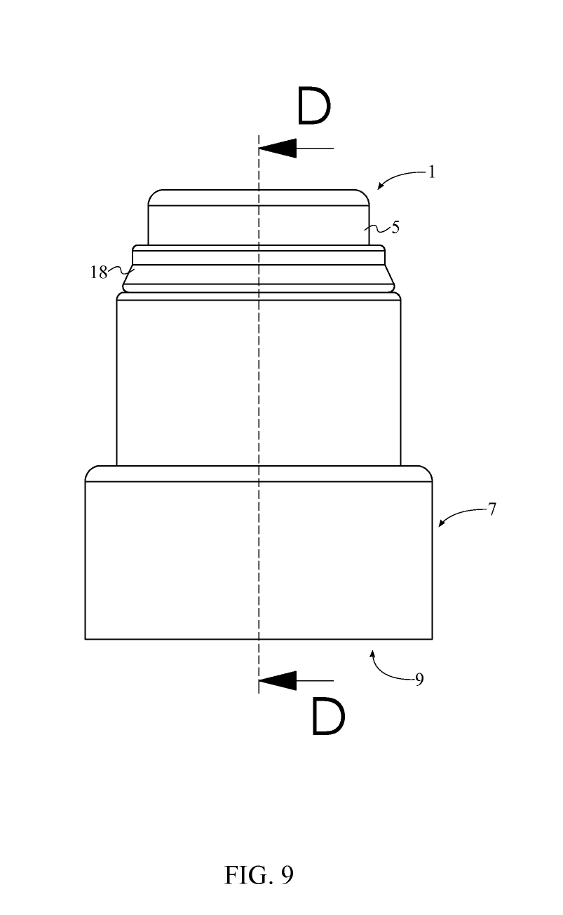

The present invention is a straw hole punching apparatus for creating a straw hole in a beverage container without any material from the beverage container falling into the beverage. The present invention is shown in FIGS. 1-10 and comprises a plunger 1, a tubular base structure 7, a dividing platform 10, a guide channel 11, a cutting implement 12, and a spring 15. The plunger 1 is depressed into the tubular base structure 7 in order to force the cutting implement 12 to slide through the guide channel 11 and punch a hole in a beverage container. The guide channel 11 additionally ensures that the cutting implement 12 does not wobble or become displaced while the plunger 1 is depressed. The dividing platform 10 prevents the plunger 1 from being depressed too far into the tubular base structure 7 while the spring 15 returns the plunger 1 to its original position after being depressed.

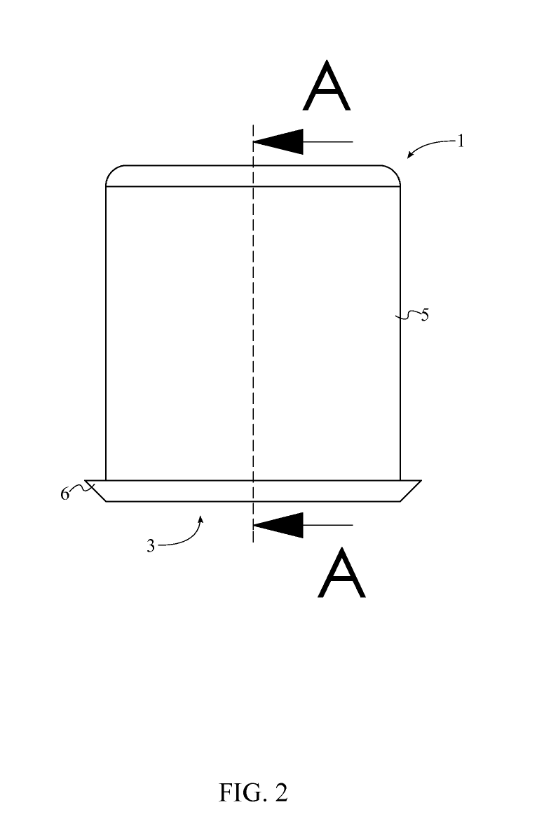

With reference to FIGS. 2-7, the plunger 1 comprises a socket 2, a plunger open end 3, and a plunger closed end 4. The socket 2 is mounted onto the plunger closed end 4 within the plunger 1 and the cutting implement 12 is adjacently mounted into the socket 2. The positioning of the socket 2 within the plunger 1 allows the socket 2 to hold the cutting implement 12 securely in place within the plunger 1 and prevents the cutting implement 12 from separating from the plunger 1. The plunger 1 is telescopically engaged into the tubular base structure 7 through the plunger open end 3. This allows the plunger 1 to be depressed into the tubular base structure 7 while the cutting implement 12 within the socket 2 is able to protrude through the plunger open end 3 and into the tubular base structure 7. The dividing platform 10 is concentrically connected within the tubular base structure 7. The dividing platform 10 serves to prevent the plunger 1 from being depressed too far into the tubular base structure 7. The guide channel 11 traverses through the dividing platform 10 with the cutting implement 12 being slidably engaged through the guide channel 11. The guide channel 11 ensures that the cutting implement 12 is able to remain in alignment with the socket 2 and the guide channel 11 when the plunger 1 is depressed into the tubular base structure 7. The spring 15 is mounted between the dividing platform 10 and the plunger closed end 4. The spring 15 is utilized to return the plunger 1 to its original position after being depressed into the tubular base structure 7 and released. Additionally, the socket 2 and the cutting implement 12 are encircled by the spring 15, allowing the cutting implement 12 to slide through the center of the spring 15.

The cutting implement 12 comprises a fixed end 13 and a cutting end 14. The fixed end 13 is circumferentially mounted into the socket 2 in order to secure the cutting implement 12 in place within the socket 2 and within the plunger 1. The socket 2 holds the fixed end 13 in place within the plunger 1 in order to ensure that the cutting implement 12 remains in alignment with the guide channel 11 when the plunger 1 is depressed into the tubular base structure 7. The cutting end 14 is positioned opposite to the fixed end 13 along the cutting implement 12 and is forced into the surface of a beverage container when the plunger 1 is depressed into the tubular base structure 7. In a preferred embodiment of the present invention, the cutting implement 12 features a tubular design. Additionally, the cutting end 14 is angled in order to create a sharp edge capable of cutting through a beverage container. The tubular design of the cutting implement 12 and the angled cutting end 14 ensure that only a partial circle is cut when the cutting implement 12 is forced into the surface of a beverage container. Cutting only a partial circle into the surface of a beverage container ensures that no material from the beverage container falls into the beverage after the plunger 1 is returned to its original position.

In the preferred embodiment of the present invention, the guide channel 11 is positioned centrally on the dividing platform 10 and the socket 2 is positioned concentrically with the guide channel 11 on the plunger closed end 4. The positioning of the guide channel 11 and the socket 2 ensures that the guide channel 11 and the socket 2 remain in alignment relative to each other. As such, the cutting implement 12 is able to remain in alignment with both the socket 2 and the guide channel 11 while the present invention is in use.

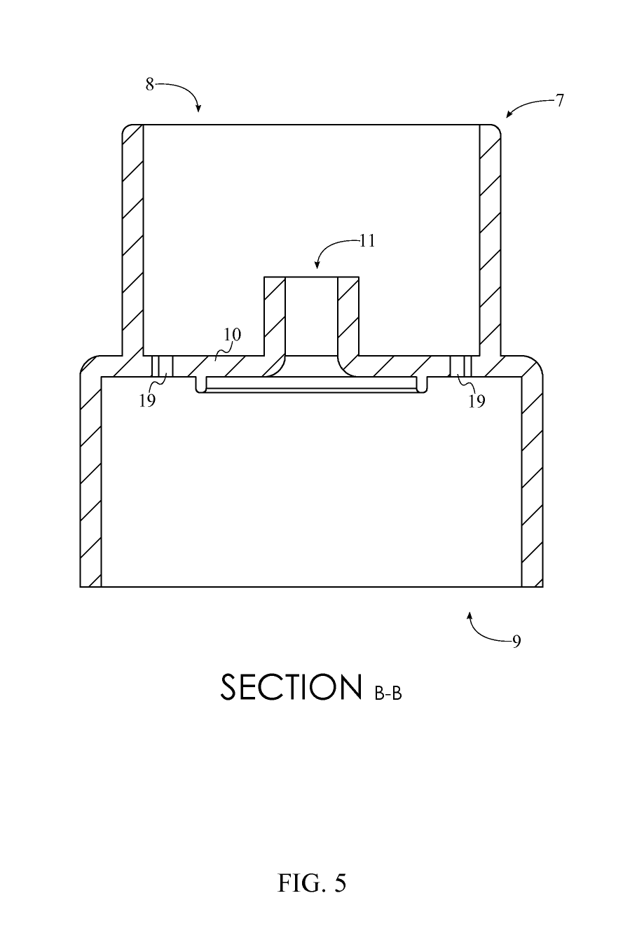

As shown in FIG. 5, the tubular base structure 7 comprises a first base open end 8 and a second base open end 9 with the dividing platform 10 positioned in between the first base open end 8 and the second base open end 9. The plunger 1 may be depressed into the first base open end 8 while the dividing platform 10 ensures that the plunger 1 is not depressed too far into the tubular base structure 7. Prior to use of the present invention, the second base open end 9 is placed over a portion of a beverage container, such as the cap of the beverage container.

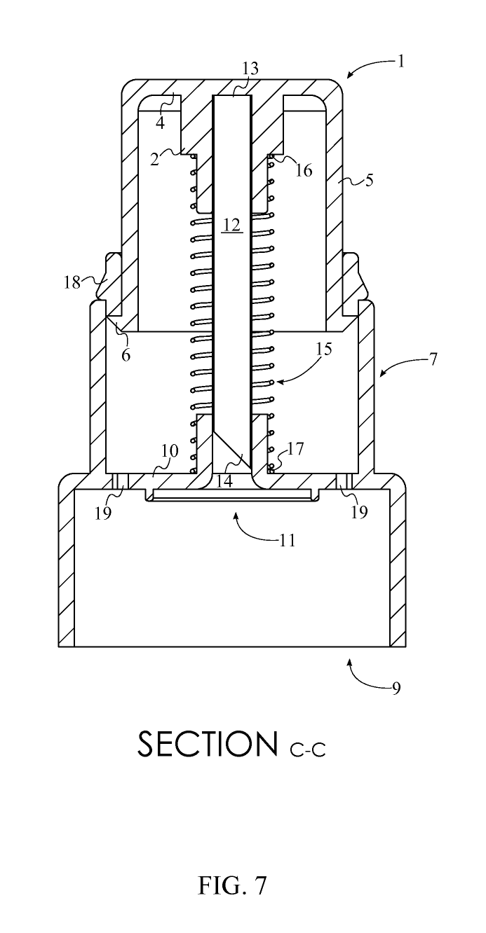

With reference to FIG. 1 and FIG. 7, the present invention further comprises a spacing ring 18. The spacing ring 18 prevents the plunger 1 from being forcibly ejected from the tubular base structure 7 due to force provided by the spring 15 when the plunger 1 is released after being depressed. As such, the spacing ring 18 serves to hold the plunger 1 in its original position after being released. The plunger 1 further comprises an annular body 5 and a lip 6. The lip 6 is externally connected around the annular body 5, adjacent to the plunger open end 3. The spacing ring 18 is internally connected around the first base open end 8. As such, the lip 6 and the spacing ring 18 hold the plunger 1 in place within the tubular base structure 7 and prevent the plunger 1 from separating from the tubular base structure 7. The spacing ring 18 is positioned in between the annular body 5 and the tubular base structure 7, allowing the lip 6 and the spacing ring 18 to hold the plunger 1 in place. The lip 6 remains pressed against the bottom of the spacing ring 18 due to the spring 15 pressing against the plunger 1, thus holding the plunger 1 in place. While the lip 6 prevents the plunger 1 from being separated from the tubular base structure 7, the plunger 1 is still able to be depressed and slide within the tubular base structure 7 due to the fact that the lip 6 is slidably mounted within the tubular base structure 7 in between the dividing platform 10 and the spacing ring 18.

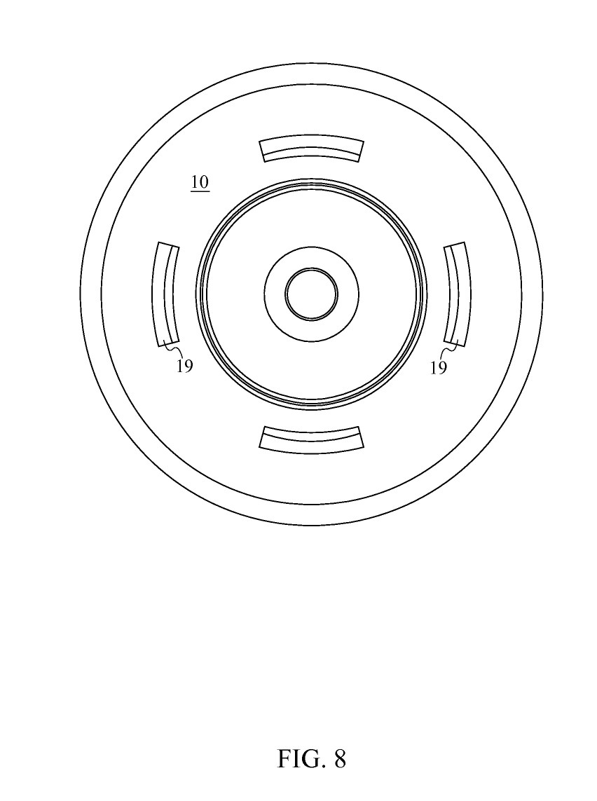

The present invention further comprises a plurality of pressure equalization holes 19. The plurality of pressure equalization holes 19 traverses through the dividing platform 10. As such, the plurality of pressure equalization holes 19 allow air to travel freely from the first base open end 8 through the dividing platform 10 to the second base open end 9 when the plunger 1 is depressed into the tubular base structure 7. The plurality of pressure equalization holes 19 allows the air pressure within the tubular base structure 7 to equalize as the plunger 1 is being depressed, facilitating the act of depressing the plunger 1. When the plunger 1 is depressed, air pressure is built up within the plunger 1. The air pressure is then able to release through the plurality of pressure equalization holes 19. The plurality of pressure equalization holes 19 is positioned radially about the dividing platform 10 as shown in FIG. 8. This allows the plurality of pressure equalization holes 19 to efficiently dissipate the compressing air within the plunger 1 as the plunger 1 is depressed into the tubular base structure 7.

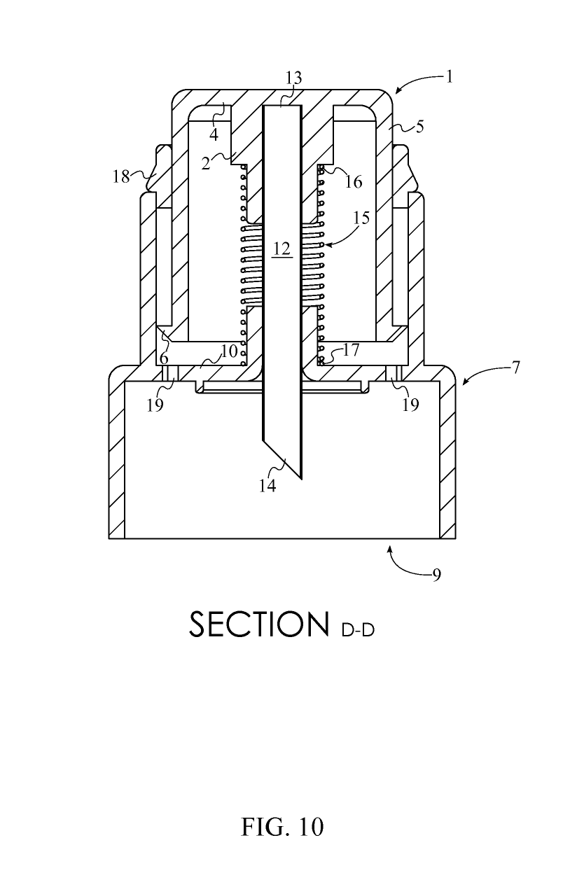

The spring 15 comprises a first spring end 16 and a second spring end 17. The socket 2 is encircled by the first spring end 16 while the guide channel 11 is encircled by the second spring end 17. This allows the cutting implement 12 to slide freely through the center of the spring 15. The spring 15 serves to return the plunger 1 to its original position after the plunger 1 has been depressed and released. Again referring to FIG. 7 and FIG. 10, the first spring end 16 is pressed against the plunger closed end 4 and the second spring end 17 is pressed against the dividing platform 10. This allows the spring 15 to forcibly return the plunger 1 to its primed configuration while the lip 6 and the spacing ring 18 prevent the plunger 1 from separating from the tubular base structure 7.

As shown in FIG. 7, prior to the plunger 1 being depressed, the cutting end 14, the lip 6, and the spacing ring 18 are in a primed configuration. The cutting end 14 is positioned in between the plunger 1 and the dividing platform 10, preventing the cutting end 14 from coming into contact with the surface of a beverage container until the plunger 1 is depressed. The lip 6 is pressed against the spacing ring 18 due to the first spring end 16 being pressed against the plunger closed end 4 and the second spring end 17 being pressed against the dividing platform 10. The force provided by the spring 15 additionally serves to return the plunger 1 to its primed configuration after the plunger 1 has been depressed and subsequently released.

Prior to utilizing the present invention, the second base open end 9 is placed over a portion of a beverage container, such as the cap of a beverage container. Referring to FIG. 10, when the plunger 1 is depressed, the cutting end 14 and the lip 6 are in a pressed configuration. The cutting end 14 is positioned adjacent to the dividing platform 10, opposite to the plunger 1. The lip 6 is positioned adjacent to the dividing platform 10. The dividing platform 10 prevents the plunger 1 from being depressed too far into the tubular base structure 7 while allowing the cutting end 14 to punch a hole in the beverage container attached to the second base open end 9. In a preferred embodiment of the present invention, the cutting end 14 only punches a partial circle into the beverage container in order to prevent any material of the beverage container from falling into the beverage. In the pressed configuration, the spring 15 is compressed. The force exerted by the first spring end 16 pressing against the plunger closed end 4 and the second spring end 17 pressing against the dividing platform 10 allows the plunger 1 to return to its original position when the plunger 1 is released.

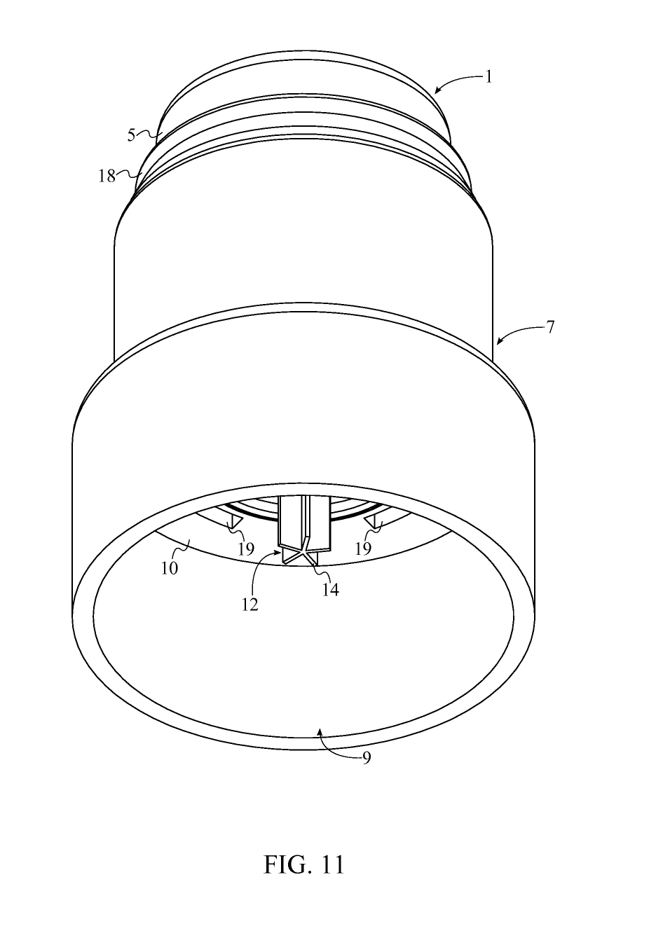

The design of the cutting implement 12 may vary in alternative embodiments of the present invention. An alternative embodiment of the present invention is shown in FIG. 11. In this alternative embodiment, the cutting implement 12 features a star-shaped design in lieu of a tubular design as in the preferred embodiment. The star-shaped alternative cutting implement 12 does not feature an angled cutting end 14. This alternative cutting implement 12 is able to create a star-shaped hole in the surface of a beverage container when the plunger 1 is depressed.

Although the invention has been explained in relation to its preferred embodiment, it is to be understood that many other possible modifications and variations can be made without departing from the spirit and scope of the invention as hereinafter claimed.

What is claimed is:

1. A hole punching apparatus comprises:
a plunger;
a tubular base structure;
a dividing platform;
a guide channel;
a cutting implement;
a spring;
the plunger comprises a socket, a plunger open end, and a plunger closed end;
the socket being mounted onto the plunger closed end within the plunger;
the cutting implement being adjacently mounted into the socket;
the plunger being telescopically engaged into the tubular base structure through the plunger open end;
the dividing platform being concentrically connected within the tubular base structure;
the guide channel traversing through the dividing platform;
the cutting implement being slidably engaged through the guide channel;
the spring being mounted between the dividing platform and the plunger closed end; and
the socket and the cutting implement being encircled by the spring.

2. The hole punching apparatus as claimed in claim 1 further comprises:
the cutting implement comprises a fixed end and a cutting end;
the fixed end being circumferentially mounted into the socket; and
the cutting end being positioned opposite to the fixed end along the cutting implement.

3. The hole punching apparatus as claimed in claim 1 further comprises:
the guide channel being positioned centrally on the dividing platform; and
the socket being positioned concentrically with the guide channel on the plunger closed end.

4. The hole punching apparatus as claimed in claim 1 further comprises:
the tubular base structure comprises a first base open end and a second base open end; and
the dividing platform being positioned in between the first base open end and the second base open end.

5. The hole punching apparatus as claimed in claim 1 further comprises:
a spacing ring;
the plunger further comprises an annular body and a lip;
the lip being externally connected around the annular body, adjacent to the plunger open end;
the spacing ring being internally connected around a first base open end of the tubular base structure;
the spacing ring being positioned in between the annular body and the tubular base structure; and
the lip being slidably mounted within the tubular base structure in between the dividing platform and the spacing ring.

6. The hole punching apparatus as claimed in claim 1 further comprises:
a plurality of pressure equalization holes;
the plurality of pressure equalization holes traversing through the dividing platform; and
the plurality of pressure equalization holes being positioned radially about the dividing platform.

7. The hole punching apparatus as claimed in claim 1 further comprises:
the spring comprises a first spring end and a second spring end;
the socket being encircled by the first spring end;
the guide channel being encircled by the second spring end;
the first spring end being pressed against the plunger closed end; and
the second spring end being pressed against the dividing platform.

8. The hole punching apparatus as claimed in claim 1 further comprises:
wherein a cutting end of the cutting implement, a lip of the plunger, and a spacing ring positioned adjacent to a first base open end of the tubular base structure are in a primed configuration;
the cutting end being positioned in between the plunger and the dividing platform; and
the lip being pressed against the spacing ring.

9. The hole punching apparatus as claimed in claim 1 further comprises:
wherein a cutting end of the cutting implement and a lip of the plunger are in a pressed configuration;
the cutting end being positioned adjacent to the dividing platform, opposite to the plunger; and
the lip being positioned adjacent to the dividing platform.

10. A hole punching apparatus comprises:
a plunger;
a tubular base structure;
a dividing platform;
a guide channel;
a cutting implement;
a spring;
the plunger comprises a socket, a plunger open end, and a plunger closed end;
the tubular base structure comprises a first base open end and a second base open end;
the socket being mounted onto the plunger closed end within the plunger;
the cutting implement being adjacently mounted into the socket;
the plunger being telescopically engaged into the tubular base structure through the plunger open end;
the dividing platform being concentrically connected within the tubular base structure;
the guide channel traversing through the dividing platform;
the cutting implement being slidably engaged through the guide channel;
the spring being mounted between the dividing platform and the plunger closed end;
the socket and the cutting implement being encircled by the spring; and
the dividing platform being positioned in between the first base open end and the second base open end.

11. The hole punching apparatus as claimed in claim 10 further comprises:
the cutting implement comprises a fixed end and a cutting end;
the fixed end being circumferentially mounted into the socket; and
the cutting end being positioned opposite to the fixed end along the cutting implement.

12. The hole punching apparatus as claimed in claim 10 further comprises:
the spring comprises a first spring end and a second spring end;
the guide channel being positioned centrally on the dividing platform;
the socket being positioned concentrically with the guide channel on the plunger closed end;
the socket being encircled by the first spring end;
the guide channel being encircled by the second spring end;
the first spring end being pressed against the plunger closed end; and
the second spring end being pressed against the dividing platform.

13. The hole punching apparatus as claimed in claim 10 further comprises:
a spacing ring;
the plunger further comprises an annular body and a lip;
the lip being externally connected around the annular body, adjacent to the plunger open end;
the spacing ring being internally connected around a first base open end of the tubular base structure;
the spacing ring being positioned in between the annular body and the tubular base structure; and
the lip being slidably mounted within the tubular base structure in between the dividing platform and the spacing ring.

14. The hole punching apparatus as claimed in claim 10 further comprises:
a plurality of pressure equalization holes;
the plurality of pressure equalization holes traversing through the dividing platform; and
the plurality of pressure equalization holes being positioned radially about the dividing platform.

15. The hole punching apparatus as claimed in claim 10 further comprises:
wherein a cutting end of the cutting implement, a lip of the plunger, and a spacing ring positioned adjacent to the first base open end of the tubular base structure are in a primed configuration;
the cutting end being positioned in between the plunger and the dividing platform; and
the lip being pressed against the spacing ring.

16. The hole punching apparatus as claimed in claim 10 further comprises:
wherein a cutting end of the cutting implement and a lip of the plunger are in a pressed configuration;
the cutting end being positioned adjacent to the dividing platform, opposite to the plunger; and
the lip being positioned adjacent to the dividing platform.
